(19) United States
(12) Patent Application Publication
(10) Pub. No.: US 2020/0131077 A1
(43) Pub. Date: Apr. 30, 2020

(54) OPTICAL MATERIAL FOR LIGHT GUIDE PLATES AND LIGHT GUIDE PLATE

(71) Applicant: AGC INC., Tokyo (JP)

(72) Inventors: Nobuhiko TAKESHITA, Tokyo (JP); Yusuke ARITA, Tokyo (JP); Akio SUGURO, Tokyo (JP)

(73) Assignee: AGC INC., Tokyo (JP)

(21) Appl. No.: 16/583,148

(22) Filed: Sep. 25, 2019

(30) Foreign Application Priority Data
Oct. 31, 2018 (JP) PCT/JP2018/040581

(51) Int. Cl. C03C 3/21; C03C 3/068; C03C 3/15

(52) U.S. Cl. CPC C03C 3/21; C03C 3/15; C03C 3/068

(57) ABSTRACT

An optical material for a light guide plate has a refractive index of 1.70 or more, a thickness of 1.1 mm or less, and a waviness of a surface of less than 50×10⁻⁴ degrees. The optical material may have the waviness of from 1.0×10⁻⁴ to 10×10⁻⁴ degrees. The optical material may contain glass.

### CROSS-REFERENCE TO RELATED APPLICATIONS

This application claims priority from PCT Application No. PCT/JP2018/040581 filed on Oct. 31, 2018, the entire subject matter of which is incorporated herein by reference.

### BACKGROUND OF THE INVENTION

### Technical Field

The present invention relates to an optical material to be used for light guide plates.

### Background Art

In recent years, head mount displays (HMDs) being applicable for AR, VR, MR, etc. have come to attract attention. It is common to use large refractive index materials such as glass, resins, etc. for a light guide plate constituting these optical devices.

Various studies have been made for light guide plates having superior light guiding characteristics. For example, it is common to control the total thickness deviation (TTV) of a light guide plate to solve a hue problem called a rainbow effect, and it is common to control a root mean square roughness (Rq) of a light guide plate for preventing luminance reduction due to light scattering (Patent literatures 1 to 3).

Patent literature 1: WO 2018/135193 A1

Patent literature 2: WO 2016/181812 A1

Patent literature 3: WO 2017/086322 A1

However, in recent years, due to increase in the performance required for products, no optical material having light guiding characteristics capable of attaining satisfactory weight reduction, size reduction, and a long optical path has been realized. More specifically, there has been a problem that, even when TTV and Rq are set within proper ranges, an occurrence of deviation of reflection angles that disables reflection of light to a desired position cannot be prevented.

In these circumstances, it is desired to provide an optical material that has superior light guiding characteristics with reduced reflection angle deviation and hence is suitable for miniaturization of a light guide plate and elongation of an optical path of the light guide plate.

### BRIEF SUMMARY OF THE INVENTION

The present inventors have found that the above problem can be solved by an optical material having a particular refractive index, thickness, and surface undulation shape.

That is, the present invention provides an optical material for a light guide plate, having a refractive index of 1.70 or more, a thickness of 1.1 mm or less, and a waviness of less than 50×10⁻⁴ degrees.

According to the present invention, a high-performance light guide plate capable of reducing deviation of reflection angles in the light guide plate and being made thin can be manufactured.

### BRIEF DESCRIPTION OF THE DRAWINGS

FIG. 1 shows data obtained by measuring a surface state of an optical material for light guide plates in Example 1.

FIG. 2 is an explanatory diagram for describing a waviness measurement.

FIG. 3 is a simplified schematic diagram illustrating a simulation for evaluation of light guiding characteristics.

### DETAILED DESCRIPTION OF THE INVENTION

An optical material according to the present invention will be described.

### [Composition of Optical Material]

There is no limitation on the composition of the optical material according to the present invention as long as its refractive index n is 1.70 or more. The refractive index is preferably 1.75 or more, more preferably 1.78 or more, particularly preferably 1.85 or more.

As the refractive index increase, the critical angle θc of a light guide plate using the optical material decreases and the degree of freedom of designing an optical device is increased. A composition of the optical material is mainly made of a large refractive index material, and can be made of a resin or glass.

Preferable specific examples of the resin include a cycloolefin polymer, a cycloolefin copolymer, an acrylic resin, a methacrylic resin, a polycarbonate resin, a polystyrene resin, and an AS resin.

A specific example of the glass may be a composition having a refractive index of 1.70 or more that is disclosed in WO 2017/090645 A1. However, the composition of the glass is not limited to it.

Preferable specific examples of the glass include a composition containing, as represented by mol % based on oxides:

SiO₂: 0% to 70%;

B₂O₃: 0% to 50%;

MgO: 0% to 25%;

CaO: 0% to 25%;

SrO: 0% to 25%;

BaO: 0% to 35%;

Li₂O: 0% to 35%;

Na₂O: 0% to 35%;

K₂O: 0% to 35%;

Al₂O₃: 0% to 10%;

Y₂O₃: 0% to 10%;

TiO₂: 0% to 50%:

WO₃: 0% to 20%:

Nb₂O₅: 0% to 35%;

La₂O₃: 0% to 50%;

ZrO₂: 0% to 20%;

ZnO: 0% to 35%:

Gd₂O₃: 0% to 30%; and

Sb₂O₃+SnO₂: 0% to 10%.

Particularly preferable specific examples of the glass include a composition containing, as represented by mol % based on oxides:

SiO₂: 5% to 35%;

B₂O₃: 5% to 25%;

MgO: 0% to 5%;

CaO: 0% to 10%;

SrO: 0% to 10%;

BaO: 0% to 10%;

Li₂O: 0% to 10%;

Na₂O: 0% to 5%;

K₂O: 0% to 5%;

Al₂O₃: 0% to 5%;

Y₂O₃: 0% to 10%;

TiO₂: 15% to 40%:

WO₃: 0% to 5%;

Nb₂O₅: 1% to 10%;

La₂O₃: 1% to 25%;

ZrO₂: 1% to 10%;

ZnO: 0% to 5%:

Gd₂O₃: 0% to 10%; and

Sb₂O₃+SnO₂: 0% to 5%.

Glass is preferable because glass is usually larger in refractive index than resins.

### [Optical Material]

The optical material according to the present invention is manufactured by shaping the above composition into a plate-like shape and putting its surface state (described later) into a particular state.

There is no limitation on the method for shaping the optical material into a plate-like shape. For example, a common method such as extrusion molding or press forming can be used for resins and a common method such as a floating method, a fusion method, or a roll-out method can be used for glass.

The thickness of the optical material is 1.1 mm or less, preferably in a range of 0.1 mm to 1.0 mm, particularly preferably 0.3 mm to 0.7 mm. Since the thickness of the optical material is in this range, a light guide plate using the optical material develops both of thickness reduction and reduction of deviation of a light guiding position.

### [Surface Shape]

The optical material according to the present invention has a small surface undulation and hence can prevent reduction in the contrast and resolution of an image due to deviation of the reflection angle of light that travels through a light guide plate while being subjected to total reflection.

In the present invention, waviness is employed as an index representing the degree of surface undulation. The waviness is an average of slopes (in degrees) of surface local undulation in a certain region.

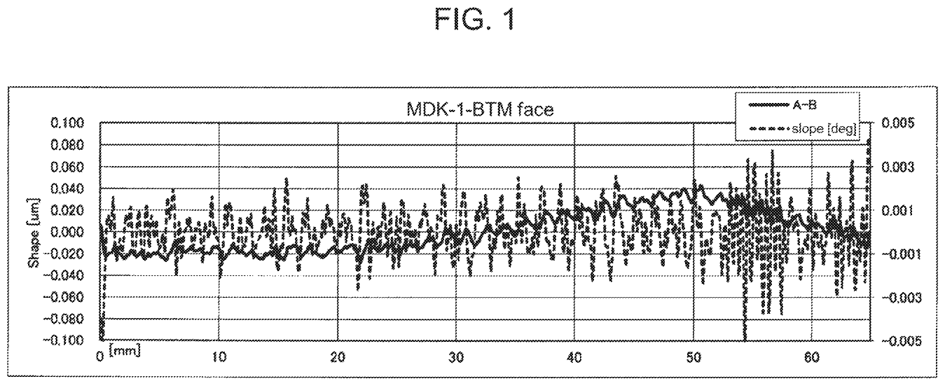

FIG. 1 shows measurement data of a surface state for measurement of waviness in Example 1. Waviness is calculated from angular variations of very fine surface projections and recesses.

A specific example of a calculation method will be described in Examples.

The waviness of the optical material according to the present invention is less than 50 (×10⁻⁴ degrees), preferably less than or equal to 20 (×10⁻⁴ degrees), particularly preferably 1.0 to 10 (×10⁻⁴ degrees).

It is preferable that the root mean square roughness (Rq) is 2.0 nm or less, since luminance reduction due to light scattering can be prevented.

Preferable specific examples of a technique for controlling the surface state within the above range include performing precision polishing using an abrasive having a very small grain diameter while measuring the W value. A cerium abrasive, colloidal silica, etc. are preferable as an abrasive. However, a method employed in the present invention is not limited to this method. For example, it is possible to use a technique of burying or covering surface undulation of the optical material using a material having a similar refractive index.

### EXAMPLES

Although the present invention will be described below with Examples and Comparative Examples, it is possible to modify the embodiment appropriately as long as the advantages of the present invention can be attained.

### <Shapes of Samples for Evaluation>

Disc-shaped glass plates having a diameter of 150 mm (6 inches) and thicknesses shown in Table 1 were used.

### <Measuring Method>

[Refractive Index]A refractive index with respect to the helium d line was measured using a refractive index meter (product name KRP-2000 manufactured by Kalnew Optical Industrial Co., Ltd.)

### [Thickness]

A thickness (d) of a sample end portion was measured using vernier calipers.

### [Waviness (W)]

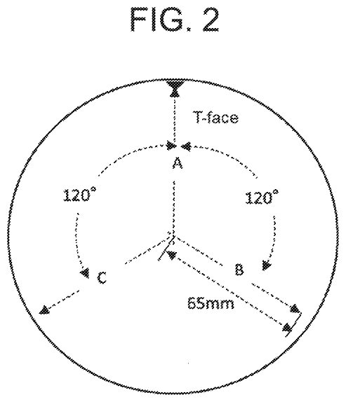

Waviness (converted into degrees) was measured by measuring a local variation of the undulation height of a substrate surface using Surfcom 579A manufactured by Tokyo Seimitsu Co., Ltd. under conditions of WCA and cutoff: 0.8 to 8 mm and then performing differentiation processing. As shown in FIG. 2, measurements were carried out along three straight lines (over 65 mm from the center to the outer edge) that divide a sample equally into three parts.

A calculation method is as follows:

Wx (waviness at a position x)=180*arctan(0.001*((maximum undulation height)−(minimum undulation height))/(distance between maximum undulation height position and minimum undulation height position))/π.

W=(average of Wx over 0 to 65 mm).

Here, the unit of the maximum undulation height and the minimum undulation height is μm, and the unit of the distance between maximum undulation height position and minimum undulation height position is mm. A final result of an average of results obtained in the ranges of the three straight lines is shown in Table 1.

### [Evaluation of Light Guiding Characteristics]

The light guiding characteristics were evaluated by determining, by a simulation, a deviation (ΔL) between light positions of ideal reflection (with no undulation) and reflections with undulations.

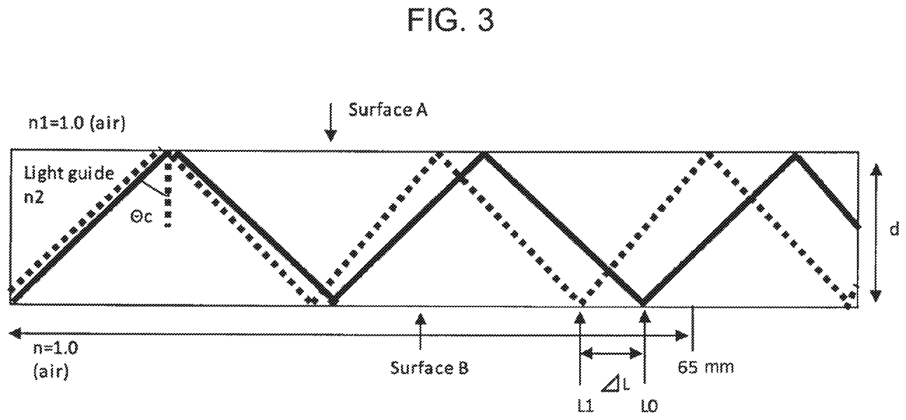

More specifically, as shown in FIG. 3, when a direct incident light traveled through an optical material, assuming that the light conducted ideal reflection (i.e., reflection in the optical material without undulation), a reference point was defined as a point at which total reflection occurred and the light guiding distance was closest to 65 mm. The distance from the incident edge to the reference point was defined as L0. The number of reflection until the light was reflected at the reference point was defined as N, including the reflection at the reference point.

Then, a light guiding distance L1 of a direct incident light having conducted total reflection for the N time under a condition that surface A had undulation and surface B had no undulation, as in Examples etc., was measured. Then, a deviation ΔL between light reaching points was obtained with an equation ΔL=|L0−L1|. A condition in which undulation existed in only one surface was employed to clarify the difference.

### Conditions:

Reflection angle: Critical angle θc under the conditions shown in Table 1 (θc=arcsin(n2/n1))

Refractive index of air: n1=1.0

Refractive index n2 of optical material: Condition shown in Table 1

Thickness d of optical material: Condition shown in Table 1

Reference light guiding distance: 65 mm

<Deviation ΔL from Distance Under Theoretical Conditions>

A: ΔL≤3.0 μm

B: 3.0 μm<ΔL<4.0 μm

C: 4.0 μm≤ΔL≤10.0 μm

D: 10.0 μm<ΔL

The evaluation results A to C were regarded as acceptable and the evaluation result D was regarded as not acceptable.

<Critical Angle θc>

A: θc≤30°

B: 30°<θc<35°

C: 35°≤θc≤40°

D: 40°<θc

The evaluation results A to C were regarded as acceptable and the evaluation result D was regarded as not acceptable.

### <Number N of Times of Reflection>

A: 90≤N

B: 60≤5N<90

C: 45≤N<60

D: N<45

The evaluation results A to C were regarded as acceptable and the evaluation result D was regarded as not acceptable.

A glass plate having a composition shown in Table 1, a width of 400 mm, and a thickness of 1 mm was manufactured by a glass melt forming method and a disc having a radius of 152 mm was cut out from a center portion of this plate using a glass cutter.

Then the disc was ground and polished using a double-sided polishing machine (16B-N/F manufactured by Hamai Industries Ltd.) until the thickness was reduced to 0.507 mm. The disc was thereafter subjected to chamfering and the radius was adjusted to 150 mm.

Finally, the disc was subjected to double-sided precision polishing using a cerium abrasive until the waviness was adjusted to a value shown in Table 1. A sample for evaluation having a thickness of 0.500 mm was produced. Evaluation results are shown in Table 1.

### Examples 2 to 8 and Comparative Examples 1 to 3

Samples for evaluation were produced by the same operation as in Example 1 except that the conditions were changed as shown in Table 1.

As for Examples 3 and 4 and Comparative Examples 1 and 2, the polishing conditions were changed so that the polishing rates in the final double-sided precision polishing in Examples 3 and 4 and Comparative Example 1 became higher than in Example 1 by 10%, 20%, and 40%, respectively. Evaluation results are shown in Table 1.

TABLE 1

| | | | | | Evaluation | | |
|---|---|---|---|---|---|---|---|
| | | | | | | | Number of |
| | | | | | | Critical | times of |
| | | Refractive | Thickness | Waviness | | angle | reflection |
| | Composition | index (n2) | (mm) | (degrees) | ΔL (μm) | (θc) | (N) |
| Ex. 1. | 1 | 1.79 | 0.5 | 8.3 × 10⁻⁴ | 2.0 (A) | 34.0 (9) | 96 (A) |
| Ex. 2 | 2 | 1.78 | 0.5 | 8.3 × 10⁻⁴ | 2.0 (A) | 34.2 (B) | 95 (A) |
| Ex. 3 | 1 | 1.79 | 0.5 | 13.3 × 10⁻⁴ | 3.2 (B) | 34.0 (B) | 96 (A) |
| Ex. 4 | 1 | 1.79 | 0.5 | 16.7 × 10⁻⁴ | 4.1 (C) | 34.0 (B) | 96 (A) |
| Ex. 5 | 3 | 2.09 | 0.5 | 8.3 × 10⁻⁴ | 2.2 (A) | 28.5 (A) | 119 (A) |
| Ex. 6 | 4 | 1.7 | 0.5 | 8.3 × 10⁻⁴ | 2.2 (A) | 36.0 (C) | 89 (B) |
| Ex. 7 | 1 | 1.79 | 1 | 8.3 × 10⁻⁴ | 1.0 (A) | 34.0 (B) | 48 (C) |
| Ex. 8 | 1 | 1.79 | 0.2 | 8.3 × 10⁻⁴ | 5.0 (C) | 34.0 (B) | 241 (A) |
| Comp. | 1 | 1.79 | 0.5 | 50 × 10⁻⁴ | 12.2 (D) | 34.0 (B) | 96 (A) |
| Ex. 1 | | | | | | | |
| Comp. | 5 | 1.51 | 0.5 | 8.3 × 10⁻⁴ | 1.9 (A) | 41.5 (D) | 73 (B) |
| Ex. 2 | | | | | | | |
| Comp. | 1 | 1.79 | 1.2 | 8.3 × 10⁻⁴ | 2.0 (A) | 34.0 (B) | 40 (D) |
| Ex. 3 | | | | | | | |

### (Mass %)

Glass composition 1: B₂O₃ (19.5), SiO₂ (5.3), La₂O₃ (26.4), Gd₂O₃ (13.3), ZnO (16.7). Li₂O (1.3), ZrO₂ (1.8), Ta₂O₅ (9.8). WO₃ (6.0)
Glass composition 2: Bi₂O₃ (20.8), SiO₂ (4.5), La₂O₃ (25.4), Gd₂O₃ (17.5), ZnO (15.0), Li₂O (1.7), ZrO₂ (1.8), Ta₂O₅ (9.9), WO₃ (3.4)
Glass composition 3: Bi₂O₃ (68.9), B₂O₃ (7.8), TeO₂ (12.4). P₂O₅ (6.3), ZnO (1.8), TiO₂ (2.8)
Glass composition 4: B₂O₃ (42.7), Li₂O (2.5), ZnO (9.7), La₂O₃ (34.0), Gd₂O₃ (11.0), Sb₂O₃ (0.1)
Glass composition 5: P₂O₅ (71.0). B₂O₃ (2.0), K₂O (13.0)

Measurement results of TTV and Rq in Example 1 and Comparative Example 1 are shown in Table 2. These results show that reflection angle deviations may become large if the waviness is not within the range prescribed in the present invention even when TTV and Rq values are respectively the same.

TABLE 2

| | Waviness | | | Evaluation |
|---|---|---|---|---|
| | (degrees) | TTV (μm) | Rq (nm) | ΔL (μm) |
| Ex. 1 | 8.3 × 10⁻⁴ | 0.1 | 2.0 | 2.0 (A) |
| Comp. Ex. 1 | 50 × 10⁻⁴ | 0.1 | 2.0 | 12.2 (D) |

1. An optical material for a light guide plate, having a refractive index of 1.70 or more, a thickness of 1.1 mm or less, and a waviness of a surface of less than 50×10⁻⁴ degrees.

2. The optical material for a light guide plate according to claim 1, wherein the waviness is from 1.0×10⁻⁴ to 10×10⁻⁴ degrees.

3. The optical material for a light guide plate according to claim 1, comprising a glass.

4. The optical material for a light guide plate according to claim 3, wherein the glass comprising, as represented by mol % based on oxides:
SiO₂: 0% to 70%;
B₂O₃: 0% to 50%;
MgO: 0% to 25%;
CaO: 0% to 25%;
SrO: 0% to 25%;
BaO: 0% to 35%;
Li₂O: 0% to 35%;
Na₂O: 0% to 35%;
K₂O: 0% to 35%;
Al₂O₃: 0% to 10%;
Y₂O₃: 0% to 10%;
TiO₂: 0% to 50%;
WO₃: 0% to 20%;
Nb₂O₅: 0% to 35%;
La₂O₃: 0% to 50%;
ZrO₂: 0% to 20%;
ZnO: 0% to 35%;
Gd₂O₃: 0% to 30%; and
Sb₂O₃+SnO₂: 0% to 10%.

5. The optical material for a light guide plate according to claim 1, wherein the thickness is from 0.3 to 0.7 mm.

6. A light guide plate comprising the optical material for a light guide plate according to claim 1.
